(19) United States
(12) Patent Application Publication
(10) Pub. No.: US 2004/0144227 A1
(43) Pub. Date: Jul. 29, 2004

(54) Food slicing apparatus

(76) Inventor: Timothy J. White, Lewisville, TX (US)

Correspondence Address: Michael L. Diaz, Michael L. Diaz, P.C., Suite 200, 555 Republic Drive, Plano, TX, 75074, US

(21) Appl. No.: 10/352,453

(22) Filed: Jan. 28, 2003

(51) Int. Cl. B26D 5/08; B26D 1/54

(52) U.S. Cl. 83/523

(57) ABSTRACT

A meat slicing apparatus for cutting meat and collecting residue from the meat. The meat slicing apparatus includes a container having four walls and a bottom surface. Each wall has a plurality of vertically aligned slots running from a top portion of the container to a distance slightly above the bottom surface. Each slot is aligned with a corresponding slot located on an opposite wall. A knife is positioned within corresponding slots to cut the meat held in the container. The container collects any juices or residue coming from the meat. The apparatus also includes a retaining utensil having several prongs for holding and handling the meat.

### BACKGROUND OF THE INVENTION

1. Technical Field of the Invention

This invention relates to food preparation devices, and more particularly, to an apparatus for holding meat during cutting of the meat.

2. Description of Related Art

Quite often a cook preparing food must cut or slice the food prior to cooking it. However, with many foods, and meat in particular, there are several problems which are encountered. First, meat in its raw form, can be quite messy. Additionally, many raw meat products have salmonella bacteria which can be very dangerous if consumed by an individual. Problems arise when an area used to cut the meat is later used to prepare other foods, without properly washing the food preparation surface or utensils. Such poor hygiene in preparing food has resulted in sickness to many individuals, and in some extreme cases, death to the individuals. Since salmonella is so hazardous, food preparers must take extraordinary care in thoroughly cleaning the food preparation surface after placing meat on the surface. To properly wash the surface, hot water and soap is preferably used on the surface. Such care is often a tedious and difficult task for the food preparer. In addition, besides cleaning the surface, the food preparer must thoroughly clean his hands. An apparatus is needed which enables a food preparer to avoid the mess of cleaning up after preparing meat without requiring the food preparer to actually touch the meat.

Although there are no known prior art teachings of a device such as that disclosed herein, prior art references that discuss subject matter that bears some relation to matters discussed herein are U.S. Pat. No. 1,462,717 to Maus (Maus), U.S. Pat. No. 3,452,795 to Davies (Davies), U.S. Pat. No. 4,056,026 to Panaritis et al. (Panaritis), and U.S. Pat. No. 5,287,784 to Brockett (Brockett).

Maus discloses a slicer which permits the rapid slicing into regular portions of sections of material such as bricks of ice cream. The slicer includes a rectangular holder having an open top and bottom. The holder includes four walls having vertically aligned slots. However, Maus does not teach or suggest a bottom surface or a container for holding any residual meat juices or residue from the held material.

Davies discloses two boxes having opposite open ends adapted to slidably fit one within the other. One of the boxes is a container for the product to be cut and has two of its opposite walls having evenly spaced knife grooves which form its open end downwards and having its two other vertical walls similarly grooved and spaced. The other box has two of its opposite vertical walls are closed while its other two opposite vertical walls and the closed end wall have knife grooves running continuously through their end. The side walls are spaced to correspond to and align with the grooves of two opposite sides of the container in one interfitting relationship of the two boxes. However, Davies does not teach or suggest collecting any residual juices within the container. Davies merely discloses a device to provide uniform cutting of the meat.

Panaritis discloses a device for cutting slices of meat into a plurality of meat chunk stacks on skewers. The device includes a container whose vertical walls are provided with guide slots for a knife blade. The container is arranged to receive a stack of meat slices slightly compressed by a top plate whose bottom face has a plurality of guide grooves for facilitating the initial insertion of the knife edge into the stack. The device includes a plurality of openings in the top plate and the bottom plate for guiding skewers to be inserted through the stack of meat. The device is used in the preparation of dishes such as shish kebab, souvlaki or similar food. However, Panaritis does not teach or suggest the collection of discarded juices from the meat enclosed in the container. Panaritis suffers from the disadvantage of being a complicated mechanism for the preparation of skewers of meat.

Brockett discloses a bread slicing device designed specifically for use with loaves produced by home automatic bread baking machines. The device includes a clear cover with a built-in knife holder and a bread slicing holder. The bread slicing holder is rigid and includes two opposing parallel slicing guide side walls which extend vertically from the base of the unit along two lateral outside edges. The lower two-thirds of the side walls interior surfaces are concave forming with a concave bottom. Bread is inserted into the holder. The side walls includes a series of evenly spaced parallel vertical slots. These slots guide the cutting implement which permits accurate and consistent slices. However, Brockett does not teach or suggest the capture of juices discarded from meat.

An apparatus is needed which enables a food preparer to easily and efficiently cut meat without letting the juices or residue from the meat from running onto a surface. Thus, it would be a distinct advantage to have an apparatus which capture the juices of the meat, prevents the meat from touching the surface of the kitchen counter, and allows the food preparer to cut the meat without actually touching the meat. It is an object of the present invention to provide such an apparatus.

### SUMMARY OF THE INVENTION

In one aspect, the present invention is a meat slicing apparatus. The apparatus includes a container for holding and handling meat during preparation of the meat. The container includes four walls and a bottom surface to form an interior area for holding the meat and collecting any residue from the meat. Each wall has several vertically aligned slots running from a top portion of the container to a distance slightly above the bottom surface. Each slot is aligned with a corresponding slot located on an opposite wall. The meat is positioned within the interior area of the container and cut by positioning a cutting utensil within two corresponding vertically aligned slots to cut the meat.

In another aspect, the present invention is a meat slicing apparatus. The apparatus includes a container for holding and handling meat during preparation of the meat. The container includes four walls and a bottom surface which forms an interior area for holding the meat and collecting any residue from the meat. Each wall has a plurality of vertically aligned slots running from a top portion of the container to a distance slightly above the bottom surface. Each slot is aligned with a corresponding slot located on an opposite wall. The apparatus also includes a retaining utensil having several prongs for retaining and handling the meat within the interior area of the container. The meat is positioned within the interior area of the container and cut by positioning a cutting utensil within two corresponding vertically aligned slots.

In still another aspect, the present invention is a meat slicing system. The system includes a container for holding and handling meat during preparation of the meat. The container includes four walls and a bottom surface which forms an interior area for holding the meat and collecting any residue from the meat. Each wall has several vertically aligned slots running from a top portion of the container to a distance slightly above the bottom surface. Each slot is aligned with a corresponding slot located on an opposite wall. The apparatus also includes a retaining utensil for retaining the meat within the interior area of the container and a knife for cutting the meat held within the interior area of the container. The meat is positioned within the interior area of the container and cut by positioning the knife within two corresponding vertically aligned slots.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front perspective view of a meat slicing apparatus in the preferred embodiment of the present invention; and

FIG. 2 is a front perspective view of the container without the knife or the multi-pronged utensil.

### DETAILED DESCRIPTION OF EMBODIMENTS

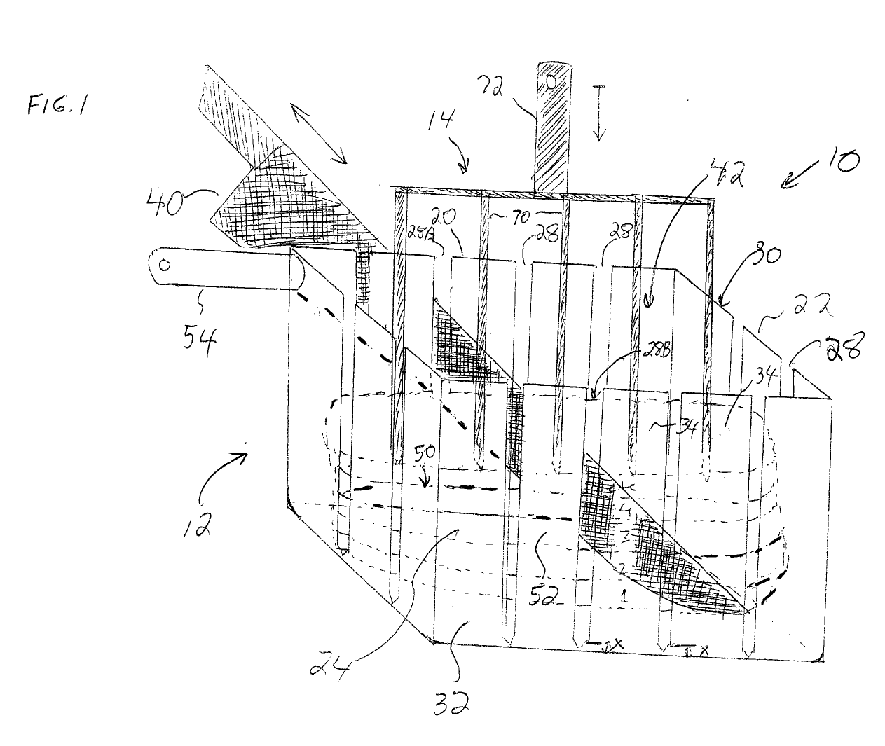

An apparatus for holding meat without allowing its juices to escape onto another surface is disclosed. FIG. 1 is a front perspective view of a meat slicing apparatus 10 in the preferred embodiment of the present invention. The meat slicing apparatus includes a container 12 and a multi-pronged utensil 14. The container includes four walls 20, 22, 24, and 26. Each wall includes a plurality of vertically aligned access slots 28 running from a top portion 30 of the container to a distance X slightly above a bottom surface 32 of the container. Between each slot is a wall section 34. The container may be constructed of any non-porous substance. Preferably, the container is constructed of a substance which is dishwasher-safe.

Each access slot 28 is aligned with a corresponding slot located on an opposite wall. For example, slot 28A located on wall 20 is aligned with slot 28B on wall 24. As illustrated, a knife 40 may be positioned in a straight vertical orientation within an interior portion 42 of the container 12 by placing the knife through the slots 28A and 28B.

The interior portion 42 of the container 12 includes a meat holding area 50 for holding meat 52. The slots 28 run down to the distance X. Along an interior perimeter on the bottom surface 32 of the container may optionally include a channel for gathering juices escaping from the meat.

The multi-pronged utensil 14 includes a plurality of prongs 70. In the preferred embodiment of the present invention, the prongs are spaced to be aligned with at least two adjacent wall sections 34. Therefore, when using the utensil 14, the prongs are aligned so that when the knife 40 is positioned within the slots, the prongs are not obstructing movement of the knife. The utensil 14 also includes a handle 72. In an alternate embodiment of the present invention, the food preparer may or may not use the utensil 14. Additionally, the utensil may be shaped and configured in any manner allowing the food preparer to hold the meat in place. The utensil may be constructed of any durable material, preferably being constructed of a substance that is dishwasher-safe.

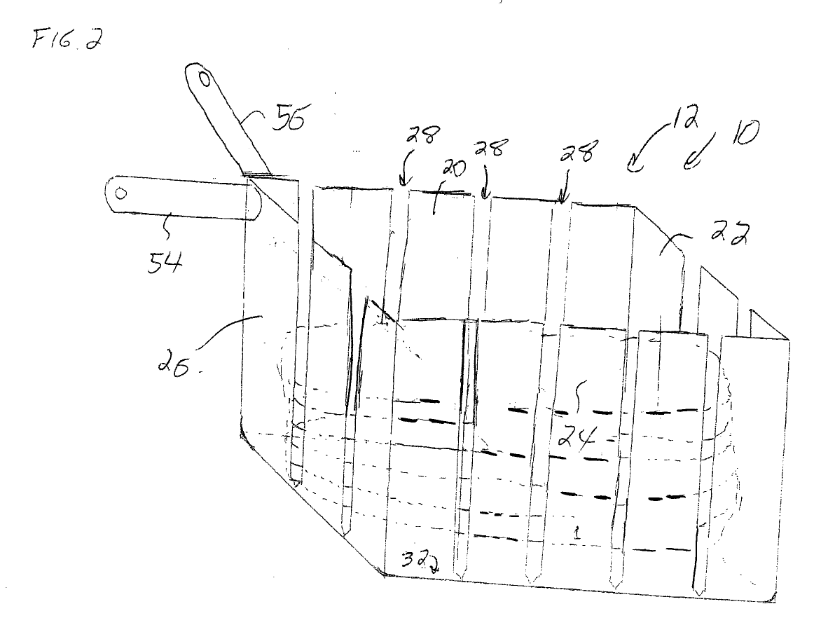

FIG. 2 is a front perspective view of the container 12 without the knife 40 or the multi-pronged utensil 14. The container optionally includes two handles 54 and 56. In the preferred embodiment of the present invention, each handle extends outwardly from a wall near its corner. The handles are preferably oriented in a perpendicular fashion from each other. In alternate embodiments of the present invention, one handle or more handles may be utilized. Additionally, the handles may be positioned anywhere on the container to allow the food preparer to easily hold the container.

With reference to FIGS. 1 and 2, the operation of the meat slicing apparatus 10 will now be explained. Meat 52 is positioned within the holding area 50. The knife 40 is positioned within two slots, such as 28A and 28B. The multi-pronged utensil 14 is used to hold the meat in place. Preferably, the prongs 70 are positioned to avoid obstructing the knife during cutting operation, such as adjacent the wall sections 34. The knife is then used to cut the meat. Similar cutting actions are used in corresponding slots across the surface of the meat. The meat may be repositioned by the food preparer by utilizing the multi-pronged utensil. The food preparer may also use one of the handles 54 or 56 as desired to hold the container steady. Any juices escaping from the meat are collected at the bottom surface 32 of the container 12. Once the meat is cut as desired, the meat is removed from the container. The container, knife and multi-pronged utensil may then be washed. Preferably, the meat slicing apparatus is washed in a dishwasher. Since the meat is not handled by the food preparer, the food preparer is not required to wash his hands again. In addition, all the juices are collected within the container, thus removing the requirement of cleaning the kitchen surface.

The meat slicing apparatus provides many advantages for a food preparer. The present invention enables a food preparer to contain any residue or bacteria into one area which can easily be washed. Additionally, the present invention allows the food preparer to cut and prepare the meat without actually touching the meat.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A meat slicing apparatus, said apparatus comprising:
a container for holding and handling meat during preparation of the meat, said container having:
a first wall, a second wall, a third wall, a fourth wall, and a bottom surface all forming an interior area for holding the meat and collecting any residue from the meat;
each wall having a plurality of vertically aligned slots running from a top portion of the container to a distance slightly above the bottom surface, each slot being aligned with a corresponding slot located on an opposite wall;
whereby the meat is positioned within the interior area of said container and cut by positioning a cutting utensil within two corresponding vertically aligned slots to cut the meat.

2. The meat slicing apparatus of claim 1 further comprising a retaining utensil for use in retaining and handling the meat within the interior portion of said container.

3. The meat slicing apparatus of claim 2 wherein the retaining utensil is a multi-pronged utensil having a plurality of prongs for retaining the meat.

4. The meat slicing apparatus of claim 3 wherein the prongs of the multi-pronged utensil are spaced to correspond with areas of a portion of one wall between adjacent slots.

5. The meat slicing apparatus of claim 1 wherein said container includes at least one handle for holding said container stationary, the handle extending from the first wall of the container.

6. The meat slicing apparatus of claim 5 wherein said container includes a second handle extending from the second wall of said container.

7. The meat slicing apparatus of claim 1 wherein said container is constructed from a non-porous material.

8. The meat slicing apparatus of claim 7 wherein said container is safe to wash within a dishwasher.

9. The meat slicing apparatus of claim 1 wherein the bottom surface includes a channel for collecting any residue from the meat.

10. The meat slicing apparatus of claim 9 wherein the channel is located around a perimeter of the bottom surface of said container.

11. A meat slicing apparatus, said apparatus comprising:
a container for holding and handling meat during preparation of the meat, said container having:
a first wall, a second wall, a third wall, a fourth wall, and a bottom surface all forming an interior area for holding the meat and collecting any residue from the meat;
each wall having a plurality of vertically aligned slots running from a top portion of the container to a distance slightly above the bottom surface, each slot being aligned with a corresponding slot located on an opposite wall; and
a retaining utensil for retaining and handling the meat within the interior area of said container, the retaining utensil having a plurality of prongs;
whereby the meat is positioned within the interior area of said container and cut by positioning a cutting utensil within two corresponding vertically aligned slots.

12. The meat slicing apparatus of claim 11 wherein the prongs of the multi-pronged utensil are spaced to correspond with areas of wall between adjacent slots.

13. A meat slicing system, said system comprising:
a container for holding and handling meat during preparation of the meat, said container having:
a first wall, a second wall, a third wall, a fourth wall, and a bottom surface all forming an interior area for holding the meat and collecting any residue from the meat;
each wall having a plurality of vertically aligned slots running from a top portion of the container to a distance slightly above the bottom surface, each slot being aligned with a corresponding slot located on an opposite wall;
a retaining utensil for retaining the meat within the interior area of said container, the retaining utensil having a plurality of prongs; and
a knife for cutting the meat held within the interior area of said container;
whereby the meat is positioned within the interior area of said container and cut by positioning the knife within two corresponding vertically aligned slots.
